(19) United States
(12) Patent Application Publication
(10) Pub. No.: US 2010/0196783 A1
(43) Pub. Date: Aug. 5, 2010

(54) ELECTROLYTE MEMBRANE, METHOD FOR MANUFACTURING THE SAME, AND MEMBRANE ELECTRODE ASSEMBLY HAVING THE ELECTROLYTE MEMBRANE

(76) Inventor: Hiroshi Suzuki, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/439,918

(22) PCT Filed: Aug. 29, 2007
(86) PCT No.: PCT/JP2007/067246

§ 371 Date: Mar. 4, 2009

(30) Foreign Application Priority Data
Sep. 5, 2006 (JP) 2006-240106

(51) Int. Cl. H01M 8/10; H01M 8/00

(52) U.S. Cl. 429/483; 427/115

(57) ABSTRACT

To obtain an electrolyte membrane that can prevent large stress formed in the membrane due to its expansion attributable to moisturization upon operation of a fuel cell and that allows the manufacturing of a membrane electrode assembly having high performance and durability. An electrolyte membrane 1 in no moisture state is moisturized to be in a high moisture state. Intervals between a plurality of clamp pieces 21 at the periphery of an electrolyte membrane 2 expanded due to moisturization are adjusted so that an electrolyte membrane after dried is provided with a required difference in expansion rate, using the plurality of clamp pieces 21. The adjusted electrolyte membrane is dried without having to change the location of the clamp pieces 21, and an electrolyte membrane 3 in no moisture state is obtained. In this way, a plurality of regions having different expansion rates are formed in the plane of the electrolyte membrane 3.

### TECHNICAL FIELD

The present invention relates to an electrolyte membrane used for making a fuel-cell membrane electrode assembly, a method for manufacturing the same, and a membrane electrode assembly having the electrolyte membrane.

### BACKGROUND ART

A polymer electrolyte fuel cell is known as a fuel cell of one mode. As compared with that of other modes, since the polymer electrolyte fuel cell has a low operating temperature (approximately 80° C. to 120° C.), is low in cost, and can be made compact, it has been expected as an automobile power source or the like.

As shown in FIG. 7, the polymer electrolyte fuel cell comprises, as a main constituent element, a membrane electrode assembly (MEA) 50, which is sandwiched between separators 51 and 51 having a fuel (hydrogen) gas passage and an air gas passage, and a single fuel cell 52, referred to as a single cell, is thus formed. The membrane electrode assembly 50 has a structure in which an anode-side gas diffusion electrode 58a comprising an anode-side electrode catalyst layer 56a and gas diffusion layer 57a is stacked on one side of an electrolyte membrane (solid polymer electrolyte membrane) 55, which is an ion-exchange membrane, and an cathode-side gas diffusion electrode 58b comprising an cathode-side electrode catalyst layer 56b and gas diffusion layer 57b is stacked on the other side thereof.

In the membrane electrode assembly of which the fuel cell is composed, the electrolyte membrane is moisturized, thereby exhibiting proton conductivity. Further, since resin of which the electrolyte membrane is composed has hydrophilic sulfonic acid groups, a large amount of water is contained in the membrane. Thus, expansion of the membrane is caused, and as a result, dimensional change of + direction in the in-plane direction or in the membrane thickness direction is caused. Further, when the percentage of moisture content is decreased upon shutdown or the like, dimensional change of − direction is caused. Between these dimensional changes, while it is easy to control the dimensional change of a contraction direction (− direction) by designing the structure of the single cell in a certain manner, it is difficult to control the dimensional change of + direction, particularly the expansion in the in-plane direction.

When such dimensional change of the electrolyte membrane is caused due to swelling (expansion), wrinkles are caused when manufacturing the membrane electrode assembly, deterioration of the membrane due to in-plane behavior is accelerated, and peeling of the membrane off the electrode catalyst layer at the interface due to the difference in the amount of change of swelling or cracks in the electrode catalyst layer is easily caused. Thus, deterioration in the performance or the durability of the membrane electrode assembly is easily caused. In order to supplement the strength of the electrolyte membrane, an electrolyte membrane cast or laminated by a reinforcing member such as PTFE resin is known. However, it cannot be said that such electrolyte membrane is sufficient for suppressing the expansion due to the moisturization of the electrolyte resin.

In order to accommodate the above problems, Patent Document 1 proposes a stretched electrolyte membrane. The electrolyte membrane is dried while the periphery of the electrolyte membrane is fixed in a high moisture state. The document utilizes the following: namely, when the moisture content of the electrolyte membrane is large, upon drying of the membrane, the area thereof is decreased. If the periphery of the membrane is fixed in a state in which the moisture content is large and then a drying treatment is conducted, as compared with cases in which the membrane is dried without being fixed, the membrane is dried in a state in which it is pulled toward the periphery thereof, and consequently, the area of the membrane is relatively increased. Therefore, the document states that even when the percentage of moisture content of the electrolyte membrane reaches a high level during power generation, since the membrane will not expand more than the original state, damage to the membrane due to the expansion can be reduced.

### Patent Document 1: JP Patent Publication (Kokai) No. 2001-35510 A

### DISCLOSURE OF THE INVENTION

### Problems to be Solved by the Invention

In the membrane electrode assembly of which the fuel cell is composed, the percentage of moisture content of the electrolyte membrane in the in-plane direction is not uniform during power generation, and percentages of moisture content are distributed in the in-plane direction. For example, the fuel-gas entry side is easily dried, and thus, the amount of moisture content of the electrolyte membrane is caused to be low. The electrolyte membrane is caused to be in a high moisture state on the exit side due to produced water. The electrolyte membrane described in Patent Document 1, which is subjected to a drying treatment while the periphery of the membrane is fixed in a state in which the amount of moisture content is large, has a uniform expansion rate in the in-plane direction after dried. When such electrolyte membrane is incorporated as an actual membrane electrode assembly, for example, the difference in the percentage of moisture content caused between the fuel-gas entry side and exit side cannot be appropriately accommodated. As a result, a large stress is generated in the membrane, resulting in a cause of deterioration in the performance or durability of the membrane electrode assembly.

The present invention has been made in view of the above circumstances, and it is an object of the present invention to provide an electrolyte membrane having difference in expansion rate in the in-plane direction in no moisture state, so as to match the operating state of an actual fuel cell, and to provide the manufacturing method thereof. Another object is to provide a membrane electrode assembly in which the electrolyte membrane is incorporated.

### Means for Solving the Problems

The electrolyte membrane according to the present invention is an electrolyte membrane used for making a fuel-cell membrane electrode assembly, and it is characterized in that both a region maintaining an expansion rate in a high moisture state and a region maintaining an expansion rate that is lower than the expansion rate in the high moisture rate exist in the in-plane direction in no moisture state.

Also in the case of the above electrolyte membrane, when used as part of the structure of the fuel-cell membrane electrode assembly, upon power generation by the fuel cell, a region having a state in which the percentage of moisture content is high (e.g., 100 moisture state) and a region having a state in which the percentage of moisture content is lower (e.g., 80% moisture state) than the above state are formed in the plane. However, the region to be in the state in which the percentage of moisture content is higher has been subjected to a drying and fixing treatment in a state in which an expansion rate (e.g., 15%) in the in-plane direction in the high moisture state is maintained, and the region to be in the state in which the percentage of moisture content lower than the above has been subjected to a drying and fixing treatment in a state in which an expansion rate (e.g., 10%) in the in-plane direction in the low moisture state is maintained. Thus, when the electrolyte membrane is moisturized and is then caused to be in a moisturized state, the membrane will not be swollen (expanded) in both of the regions, exceeding the level in no moisture state. Further, the membrane will be stabilized in a state in which there is almost no internal stress. Therefore, the electrolyte membrane can be released from stress due to expansion of the membrane-edge portion controlled by a single cell or the like.

While the extent of the state in which the percentage of moisture content is high and the extent of the state in which the percentage of moisture content is low are set in accordance with the specification and the operating environment of a membrane electrode assembly and a fuel cell in which the electrolyte membrane is used, at least the state in which the percentage moisture content is high is normally set so that the electrolyte membrane is in a state in which the moisture content is 100%.

In the electrolyte membrane according to the present invention, the region maintaining an expansion rate in a high moisture state and the region maintaining an expansion rate lower than the expansion rate in the high moisture state may be regions whose the expansion rates change in a stepwise fashion or the regions may have a region having gradually decreasing expansion rates therebetween. Further, the region maintaining an expansion rate lower than the expansion rate in the high moisture state may be composed of a plurality of regions having different expansion rates. Alternatively, it may be a region in which the expansion rate is continuously decreased.

In the electrolyte membrane according to the present invention, the electrolyte membrane may be made of electrolyte resin (ion-exchange resin) alone. Alternatively, it may be a reinforced electrolyte membrane, i.e., a porous reinforced membrane (e.g., porous PTFE membrane) impregnated with electrolyte resin. As such electrolyte resin, an electrolyte resin used for an electrolyte membrane in a conventional polymer electrolyte fuel cell can be used as needed. As another alternative, it may be an electrolyte membrane of a mode provided with ion conductivity, the electrolyte membrane obtained by conducting a hydrolysis treatment on, e.g., fluorine-based electrolyte, which is electrolyte resin precursor lacking ion conductivity.

The present invention also discloses a membrane electrode assembly characterized in that, when a fuel cell comprising a fuel-cell membrane electrode assembly having the above electrolyte membrane as part of its structure is assembled, the electrolyte membrane is incorporated into the membrane electrode assembly so that the region maintaining an expansion rate lower than the expansion rate in a high moisture state is located on the fuel entry side and so that the region maintaining the high moisture state is located on the exit side.

When a fuel cell generates electric power, the electrolyte membrane of which the membrane electrode assembly is composed is moisturized and is then caused to be in a moisturized state. The percentage of moisture content of the electrolyte membrane in such state is not uniform in the in-plane direction: the percentage of moisture content is low on the fuel entry side (normally, the moisture content is approximately 80% while it depends on the operating state), and the moisture content reaches approximately 100% as it is gradually increased toward the exit side. In the above membrane electrode assembly according to the present invention, the electrolyte membrane is incorporated so that the region maintaining an expansion rate lower than an expansion rate in a high moisture state is located on the fuel entry side and so that the region maintaining the expansion rate in a high moisture content state is located on the exit side. Thus, when the electrolyte membrane is moisturized and is then caused to be in a moisturized state upon power generation by the fuel cell, the electrolyte membrane can be prevented from being swollen (expanded) in the in-plane direction, exceeding the level in no moisture state (it expands in the membrane thickness direction). Further, the electrolyte membrane is stabilized in a state in which there is almost no internal stress. Therefore, in the membrane electrode assembly, the occurrence of interfacial peeling between the electrolyte membrane and the electrodes can be prevented. Furthermore, since stress due to expansion of the electrolyte membrane of the membrane-edge portion controlled by the single cell is released, a long-life and high-efficiency membrane electrode assembly can be obtained. Additionally, as opposed to conventional cases, a reinforcing member does not need to be laminated in order to suppress a dimensional change of the electrolyte membrane, and it becomes possible to suppress the + side dimensional change without having to change the molecular structure of the electrolyte resin.

In the above membrane electrode assembly, the expansion rate of the electrolyte membrane maintained in no moisture state in the in-plane direction may be continuously changed from the entry side to the exit side. Alternatively, the expansion rate may be changed in a stepwise fashion.

As a method for manufacturing the above electrolyte membrane, the present invention also discloses an electrolyte-membrane manufacturing method characteristically comprising the steps of moisturizing an electrolyte membrane in no moisture state to be in a high moisture state; fixing the periphery of the electrolyte membrane expanded due to the moisturization with a plurality of clamp pieces; adjusting intervals between a plurality of clamp pieces so that the electrolyte membrane is provided with a required difference in expansion rate after dried; and drying the adjusted electrolyte membrane without having to change the location of the clamp pieces.

The electrolyte membrane used in the above manufacturing method may be a normal electrolyte membrane used in a membrane electrode assembly of which a fuel cell is composed. An arbitrary method for moisturizing the electrolyte membrane may be used, on the condition that no external force is actively applied to the electrolyte membrane. For example, the electrolyte membrane may be immersed in water in a stationary state, or it may be moisturized as it is circulated in water. It is preferable that the moisturizing treatment be conducted at a temperature approximately 80° C. to 120° C., which is the power generation temperature of a polymer electrolyte fuel cell.

In the present invention, it is desirable that the high-percentage moisture state be a maximum-percentage moisture state that is predicted when the electrolyte membrane is used in a membrane electrode assembly or the like. It is preferable that the membrane be moisturized so that the moisture content reaches 100%. Due to such moisturization, the electrolyte membrane is expanded depending on the percentage of moisture content at least in the in-plane direction. This expansion is an uncontrolled natural expansion, and it is different from active stretching due to external stress. Thus, the internal stress is significantly reduced.

The periphery of the electrolyte membrane expanded due to the moisturization is fixed by a plurality of clamp pieces. After the fixation, intervals between individual clamp pieces are adjusted, e.g., in the X and Y directions that are perpendicular to each other as needed, so that the electrolyte membrane is provided with a required difference in expansion rate after dried. Upon completion of this adjustment, portions of the electrolyte membrane between the clamp pieces are provided with slack. The clamp pieces are fixed in such state, and the electrolyte membrane are subjected to a drying treatment, so that the membrane is caused to be in no moisture state. Due to the drying, a dimensional change of the expanded electrolyte membrane occurs in the contraction direction. As a result, the slack between the clamp pieces is eliminated.

With suitable control of the intervals in the two axial directions X and Y between the clamp pieces, the electrolyte membrane is provided with both a region maintaining, as it is even after dried, an expansion state exhibited when the membrane is moisturized to be in a high moisture state (i.e., a region in which contraction does not occur due to drying) and a region maintaining an expansion rate lower than the expansion rate in the high moisture state (i.e., a region in which contraction occurs due to drying up to the state defined by the intervals between the clamps). If necessary, the obtained electrolyte membrane is cut so that it has a suitable size, and it is used as an actual electrolyte membrane as described above.

In the method for manufacturing the above electrolyte membrane, an electrolyte membrane (F-based electrolyte membrane) comprising electrolyte resin precursor lacking ion conductivity may be used as the electrolyte membrane. In such case, the step of moisturizing the electrolyte membrane in no moisture state to be in a high moisture state also functions as a step of conducting a hydrolysis treatment for providing the electrolyte resin precursor with ion conductivity, and thus the operating efficiency can be improved. Further, as compared with a conventional electrolyte membrane that is manufactured by providing electrolyte resin precursor with ion conductivity, followed by drying, the electrolyte membrane being moisturized and dried, so that it is provided with an expansion rate in a moisture content state, the electrolyte membrane according to the present invention is provided with an expansion rate in a moisture state while conducting hydrolysis for providing the electrolyte membrane precursor with ion conductivity, as in the above method. Thus, since the electrolyte membrane can be provided with an expansion rate in a moisture state in a state in which the fluidity of the electrolyte resin of which the electrolyte membrane is composed is high, as compared with the conventional electrolyte membrane, an electrolyte membrane having reduced internal stress can be obtained.

### EFFECTS OF THE INVENTION

According to the present invention, an electrolyte membrane having difference in expansion rate in no moisture state is obtained, so as to accommodate the operating state of an actual fuel cell. Thus, upon power generation by the fuel cell, it is possible to prevent large stress in the membrane due to the expansion of the electrolyte membrane, and it is possible to manufacture a membrane electrode assembly having high performance and durability.

### BRIEF DESCRIPTION OF THE DRAWINGS

FIG. 1 illustrates how a swollen electrolyte membrane is obtained.

FIG. 2 shows a state in which the swollen electrolyte membrane is fixed to a clamping device.

FIG. 3 shows a state in which intervals between individual clamp pieces are adjusted.

FIG. 4a shows a cross-sectional view taken along line Y-Y of FIG. 3, and FIG. 4b shows a cross-sectional view taken along line X-X of FIG. 3.

FIG. 5 shows a state in which an electrolyte membrane is cut out of an electrolyte membrane that has been subjected to a drying treatment.

FIG. 6 schematically shows a fuel cell comprising a membrane electrode assembly in which an electrolyte membrane according to the present invention is adopted.

FIG. 7 shows a diagram for explaining a fuel cell (single cell) and a membrane electrode assembly.

### EXPLANATIONS OF LETTERS OR NUMERALS

1 . . . electrolyte membrane, 2 . . . electrolyte membrane swollen due to moisturization, 3 . . . electrolyte membrane according to the present invention that is dried after moisturization, 10 . . . hot-water bath, 20 . . . clamping device, 21 (A1, A2, A3, B1, C1, C2, C3, and D1 to D5) . . . clamp pieces

### BEST MODE FOR CARRYING OUT THE INVENTION

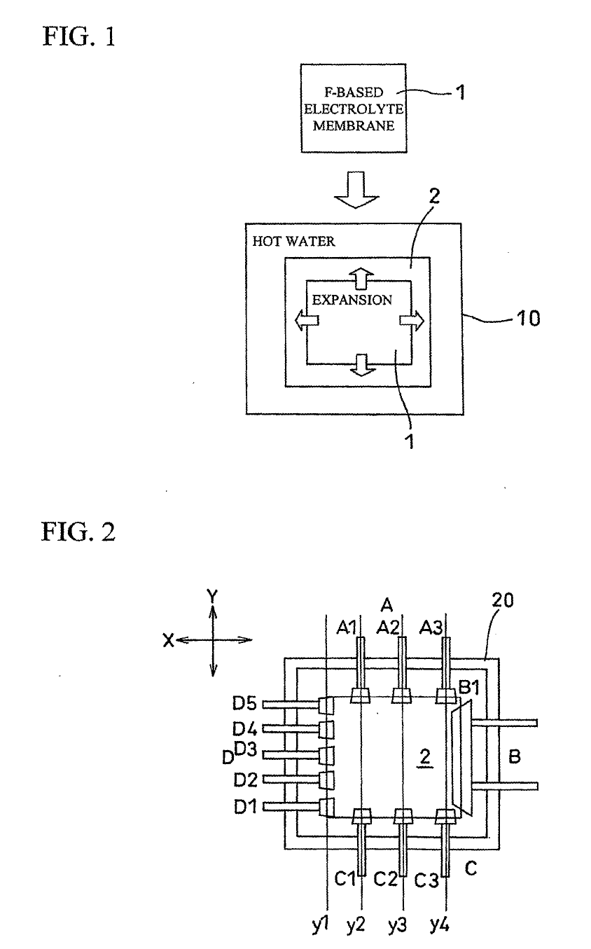

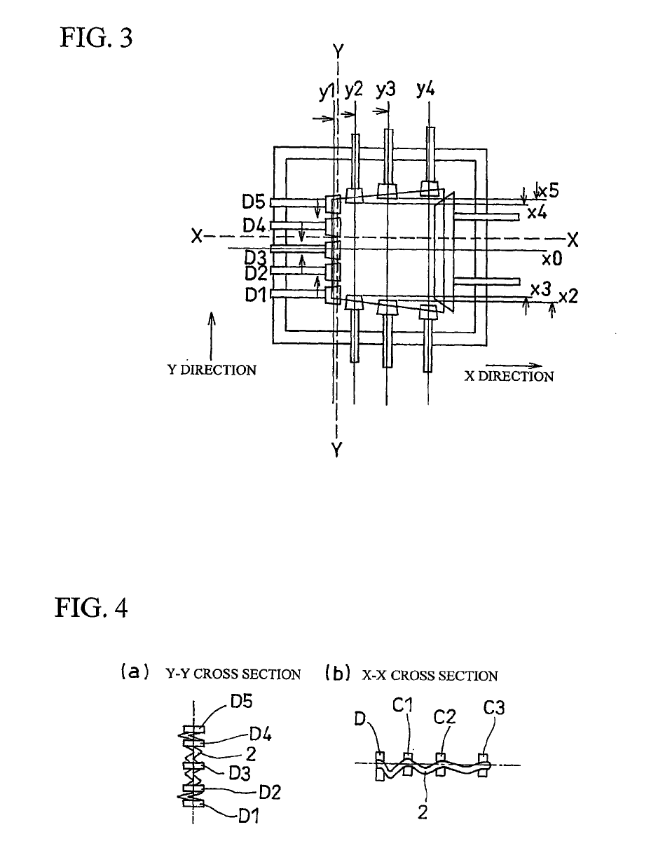

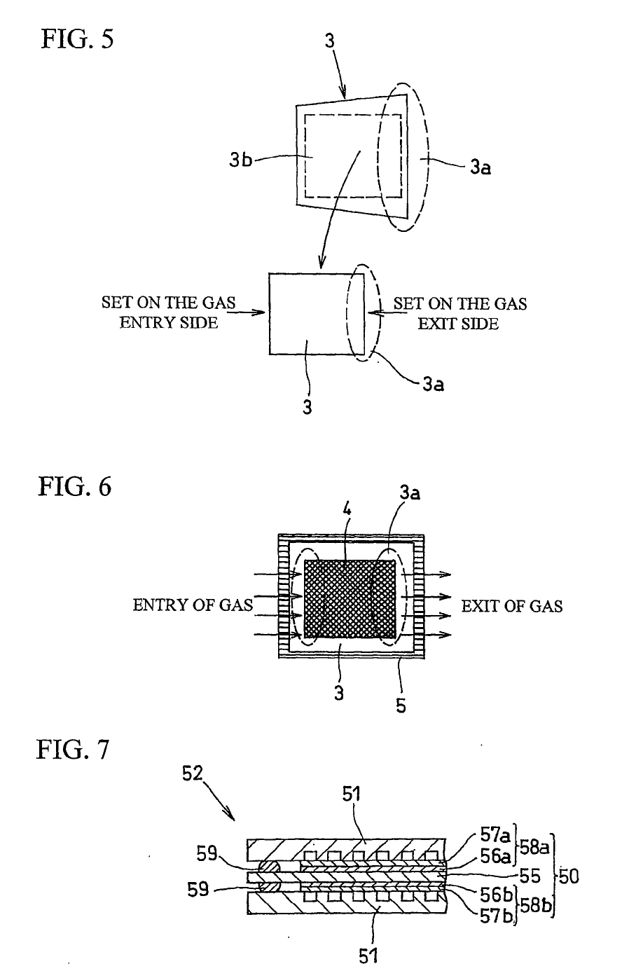

An electrolyte membrane according to the present invention and a manufacturing method thereof will be described hereafter based on embodiments with reference to the drawings. FIG. 1 illustrates how a swollen electrolyte membrane is obtained, and FIG. 2 shows a state in which the swollen electrolyte membrane is fixed to a clamping device. FIG. 3 shows a state in which intervals between individual clamp pieces are adjusted. FIG. 4a shows a cross-sectional view taken along line Y-Y of FIG. 3, and FIG. 4b shows a cross-sectional view taken along line X-X of FIG. 3. FIG. 5 shows a state in which an electrolyte membrane is cut out of an electrolyte membrane that has been subjected to a drying treatment. FIG. 6 schematically shows a fuel cell comprising a membrane electrode assembly in which an electrolyte membrane according to the present invention is used.

First, a suitable electrolyte membrane 1 is prepared. While in this example an F-based electrolyte membrane, which is an electrolyte membrane comprising electrolyte resin precursor lacking ion conductivity, is used, an electrolyte membrane of another type may be used. The electrolyte membrane 1 is placed in a hot-water bath 10, and it is then left to stand in an unconfined manner until it is in a 100% moisture state. In doing so, the water temperature is maintained in the range of 80° to 120°, which is the power generation temperature of a polymer electrolyte fuel cell. When moisturized due to moisturization, the electrolyte membrane 1 is caused to be an expanded electrolyte membrane 2 that is swollen uniformly in the thickness direction and in the in-plane direction by the amount depending on the percentage of moisture content. It is herein assumed that the expansion rate in the in-plane direction in the 100% moisture state is 15%. Further, the hydrolysis process of the F-based electrolyte membrane 1 proceeds along with moisturization, and as a result, the electrolyte resin precursor is provided with ion conductivity.

Next, the periphery of the expanded electrolyte membrane 2 in a swollen state is fixed with a plurality of clamp pieces 21 of a clamping device 20. In this example, the clamping device 20 comprises the clamp pieces 21 on four edges A, B, C, and D. Each of the clamp pieces 21 is movable in two directions, the X and Y directions, and it is adapted so that it can be fixed at the location after moved.

The edges A and C are two edges facing each other in a parallel manner. In this example, three of the clamp pieces 21, A1, A2, and A3, on the edge A, and three of the clamp pieces 21, C1, C2, and C3, on the edge C, are disposed so that they are opposite to one another. The edges B and D are also two edges facing each other in a parallel manner. In this example, a single long clamp piece B1 on the edge B is disposed opposite to five clamp pieces 21, D1 to D5, on the edge D.

All of the clamp pieces 21 are moved to a location where the periphery of the rectangular expanded electrolyte membrane 2 can be held; that is, to a location where four edges can be held, so as to clamp the expanded electrolyte membrane 2. Such state is shown in FIG. 2. In this state, the electrolyte membrane 1 has a 100% moisture content, and it exhibits a 15% expansion in the two axial directions of X and Y (in-plane direction). For convenience of explanation, the location of the clamp pieces D1 to D5 is considered to be y1, the location of the clamp pieces A1 and C1 to be y2, the location of the clamp pieces A2 and C2 to be y3, and the location of the clamp pieces A3 and C3 to be y4.

Next, intervals between a plurality of clamp pieces 21 are adjusted so that the electrolyte membrane 1 dried to be in no moisture state is provided with required regions having different expansion rates. In this example, as shown in FIG. 3, in the X direction, the clamp piece B1 is fixed and the clamp pieces A3 and C3 are also fixed as it is. Thus, the y4 is considered to be the reference position in the X direction. The clamp pieces A1, A2, C1, C2, and D1 to D5 are moved toward the reference position y4. For example, the individual clamp pieces 21 are moved so that the dried electrolyte membrane 1 is provided with a contraction of −10% between the y1 and y2, −7% between the y2 and y3, and −3% between y3 and y4.

Next, in the Y direction, the clamp pieces A3, B1, C3, and D3 are fixed. The position of the clamp piece D3 is considered to be the center (x0) in the Y direction in this case. The individual clamp pieces 21 are moved so that the dried electrolyte membrane 1 is provided with a contraction of: −7% with respect to intervals between x0 and the clamp pieces C1 and A1; that is, x3 and x4; −3% with respect to intervals between x0 and the clamp pieces C2 and A2; that is, x2 and x5; and −10% with respect to intervals between the individual clamp pieces D1 to D5.

By moving the individual clamp pieces 21 in such way, as shown in the cross section taken along Y-Y of FIG. 3; i.e., FIG. 4a, the expanded electrolyte membrane 2 is provided with slack between the individual clamp pieces near the portions held by the clamp pieces D1 to D5. The slack is also caused in the X direction (the right side in FIG. 3). Further, as shown in FIG. 4b, the expanded electrolyte membrane 2 is also provided with slack between the individual clamp pieces near the cross section taken along X-X of FIG. 3.

The expanded electrolyte membrane 2 is subjected to a drying treatment while such state is maintained. As it is dried, the expanded electrolyte membrane 2 contracts in the X and Y directions. However, since the amount of contraction is defined by the intervals between the individual clamps, for example, near the region y4 where position adjusting was not conducted and that is held by the clamp pieces B1, A3, and C3, the original 15% expansion state in the in-plane direction is maintained without change after the membrane 2 is dried. On the other hand, near the region y1 defined by the clamp pieces D1 to D5, since the individual clamp pieces have been moved to locations where −10% contraction is allowed, the region y1 contracts until it reaches a state in which an expansion of 15%-10%; that is, 5% in the in-plane direction, is generated, and the expanded electrolyte membrane 2 is then caused to be in a fixed state (no moisture state). Similarly, an expansion, 15%−7%=8%, near the region y2 and an expansion, 15%−3%=12%, near the region y3 in the in-plane direction are caused, and in such state, the expanded electrolyte membrane 2 is caused to be in a fixed state. In such state, the expanded electrolyte membrane 2 is retrieved from the clamping device 20. A retrieved electrolyte membrane 3 has a shape of a trapezoid, as shown in FIG. 5.

Namely, in the dried no-moisture-state electrolyte membrane 3 (FIG. 5), there exist both a region 3a maintaining a 15% expansion rate in a 100 moisture state and a region 3b maintaining an expansion rate (5% to 12%) in a lower moisture state in the in-plane direction.

An electrolyte membrane 3 having a required size is cut out of the electrolyte membrane 3, and gas diffusion electrodes 4 and 4 are stacked on both sides thereof with a conventionally known method, so as to form a membrane electrode assembly. The membrane electrode assembly is then sandwiched between separators 5 and 5 comprising a fuel gas passage and air gas passage, so as to form a fuel cell (single cell). In doing so, the membrane electrode assembly is incorporated so that a region maintaining an expansion rate (5% in the above example) lower than a 15% expansion rate in a 100% moisture state is located on the fuel entry side and the region 3a maintaining a 15% expansion rate in a 100% moisture state is located on the exit side.

As described above, when a fuel cell generates electric power, it is often the case that the percentage of moisture content is low on the fuel entry side (normally, about 80% moisture content), and as gradually increased, the moisture content reaches approximately 100% on the exit side. However, in the above-described membrane electrode assembly, as the electrolyte membrane 3, since an electrolyte membrane having a region previously expanded on the fuel entry side so that the expansion rate (5%) in the 80% moisture is matched and a region previously expanded on the exit side so that a 15% expansion rate in a 100% moisture state is matched are originally used, even when the electrolyte membrane is moisturized and is caused to be in a moisturized state upon power generation by the fuel cell, the electrolyte membrane can be prevented from being swollen (expanded) in the in-plane direction, exceeding the level in a no moisture state. Additionally, the electrolyte membrane is stabilized in a state in which there is almost no internal stress when swollen.

In the above description, a required swelling and drying treatment are conducted on the electrolyte membrane, and the gas diffusion electrodes are stacked, so as to form a membrane electrode stack. However, a membrane electrode stack may be made in advance and the above swelling and drying treatment may be conducted thereon.

1. An electrolyte membrane used for making a fuel-cell membrane electrode assembly, wherein both a region maintaining an expansion rate in a high moisture state and a region maintaining an expansion rate lower than the expansion rate in the high moisture state exist in the in-plane direction in no moisture state.

2. The electrolyte membrane according to claim 1, wherein the high-percentage moisture state is a state in which the moisture content of the electrolyte membrane is 100%.

3. A fuel-cell membrane electrode assembly having the electrolyte membrane according to claim 1 as part of its structure, wherein, when a fuel cell is assembled, the electrolyte membrane is incorporated into the membrane electrode assembly so that the region maintaining the expansion rate lower than the expansion rate in the high moisture state is located on a fuel entry side and so that the region maintaining the expansion rate in the high moisture state is located on an exit side.

4. A method for manufacturing the electrolyte membrane according to claim 1, the method comprises the steps of:
moisturizing an electrolyte membrane in no moisture state to be in a high moisture state;
fixing the periphery of the electrolyte membrane expanded due to the moisturization with a plurality of clamp pieces;
adjusting intervals between a plurality of clamp pieces so that the electrolyte membrane is provided with a required difference in expansion rate after dried; and
drying the adjusted electrolyte membrane to be in no moisture state without having to change the location of the clamp pieces.

5. The method for manufacturing an electrolyte membrane according to claim 4, wherein the electrolyte membrane is an electrolyte membrane comprising electrolyte resin precursor lacking ion conductivity, and the step of moisturizing the electrolyte membrane in no moisture state to be in a high moisture state is a step of conducting a hydrolysis treatment for providing the electrolyte resin precursor with ion conductivity.
